(19) United States
(12) Patent Application Publication
(10) Pub. No.: US 2018/0031182 A1
(43) Pub. Date: Feb. 1, 2018

(54) Application Method for High-Output LED AC Bulb-Replacement Assembly

(71) Applicants: Benny Ray Smith, Santa Rosa, CA (US); Peter Andrew Smith, Hidden Valley Lake, CA (US)

(72) Inventors: Benny Ray Smith, Santa Rosa, CA (US); Peter Andrew Smith, Hidden Valley Lake, CA (US)

(21) Appl. No.: 15/220,130

(22) Filed: Jul. 26, 2016

(51) Int. Cl. F21K 9/235; F21V 5/04; F21K 9/232

(52) U.S. Cl. CPC F21K 9/235; F21K 9/232; F21V 5/045; F21Y 2115/10

(57) ABSTRACT

A means for facilitating the installation of a high-output LED bulb-replacement assembly into various Fresnel lighting instruments. The invention consists of partitioning the bulb-replacement assembly into two distinct parts: a light-producing sub-assembly and an electrical-power-contact sub-assembly. This partition greatly simplifies the application of the high-output LED bulb replacement assembly to a wide variety of existing Fresnel instruments.

### CROSS-REFERENCES TO RELATED APPLICATIONS

None

### STATEMENT REGARDING FEDERALLY-SPONSORED RESEARCH OR DEVELOPMENT

Not Applicable

### MICROFICHE APPENDIX

Not Applicable

### BACKGROUND OF THE INVENTION

### 1. Field of the Invention

The invention comprises an application extension of the previous invention of a “High-Output LED AC Bulb-Replacement Assembly”

### 2. Description of the Related Art

In a previous patent application by the same persons as above, “High-Output LED AC Bulb Replacement Assembly”, a design for a single-assembly, direct, plug-in replacement for the halogen bulb used in existing lighting instruments was described. In order to provide continuity to the present invention, the background art described in that patent is repeated.

The lighting instruments that have been in use for decades employ halogen light bulbs as their light source. The power consumption of these instruments ranges from hundreds to thousands of watts. Typically, 93% or more of this power is converted to heat, leaving 7% to be converted to light. This is the impetus for many users of these instruments to desire conversion to LEDs, which can provide eight times as much light for the same power draw.

Fresnel lenses have been used for centuries to project light from a point source into a spot of variable size. The size of the projected light beam can be varied by moving the light source back and forth with respect to the lens. Since halogen bulbs emit significant infrared heat energy, the Fresnel lens that is incorporated into a typical halogen instrument must be capable of withstanding extreme heat. Such lenses are typically made from thick, stepped glass.

The halogen bulbs typically use dual-pin, bayonet or screw bases as their interface to a socket, the socket being connected to mains power via a power cord.

### BRIEF SUMMARY OF THE CURRENT INVENTION

The invention comprises a means for facilitating the installation of the high-output LED bulb-replacement assembly into various Fresnel lighting instruments. The invention consists of separating the replacement assembly into two distinct parts: a light-producing sub-assembly and an electrical-power-contact sub-assembly. This invention greatly simplifies the application of the high-output LED bulb replacement assembly to a wide variety of existing Fresnel instruments.

### SUMMARY OF THE VARIANTS OF THE INVENTION

Since there are many variations of lighting instruments which incorporate halogen or other incandescent bulbs, the present invention provides a means of fitting a set of standard, light-producing sub-assemblies to a wide variety of lighting instruments. The present invention can take various forms in order to replace the bulb in each of these instruments. There are two primary differences that distinguish the different forms of a high-output LED bulb-replacement that utilize the present invention:

a) the light-producing sub-assembly can vary in size and configuration in order to fit into the space available in a particular Fresnel instrument;
b) the specific configuration of the electrical-power-contact sub-assembly can vary in size and configuration in order to provide AC power to the light-producing assembly.

The novel and unique value of using these two sub-assemblies instead of just one assembly is that it enables much larger and therefore much brighter light-producing assemblies to be installed easily into the lighting instrument. Typically just two screws can be used to join the two sub-assemblies once both are in place within the instrument.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a perspective view of a high-output LED bulb-replacement assembly that incorporates the present invention.

FIG. 2 is a perspective view showing the application of the invention to the separation of said high-output LED bulb-replacement assembly into the light-producing sub-assembly and the electrical-power-contact sub-assembly.

### REFERENCE NUMERALS IN THE DRAWINGS

10 Complete LED light assembly
12 LED array
14 Electrical-power-contact sub-assembly
16 Light-producing sub-assembly
18 Electrical-power-contact sub-assembly
20 AC Mains Contact Pins

### DETAILED DESCRIPTION OF THE INVENTION

The invention consists of the separation of a high-output LED bulb-replacement assembly into two distinct parts: a light-producing sub-assembly and an electrical-power-contact sub-assembly.

These two parts complement one another. Their separation allows a high-output LED bulb-replacement assembly to be installed into spaces where, fully assembled, it could not be inserted.

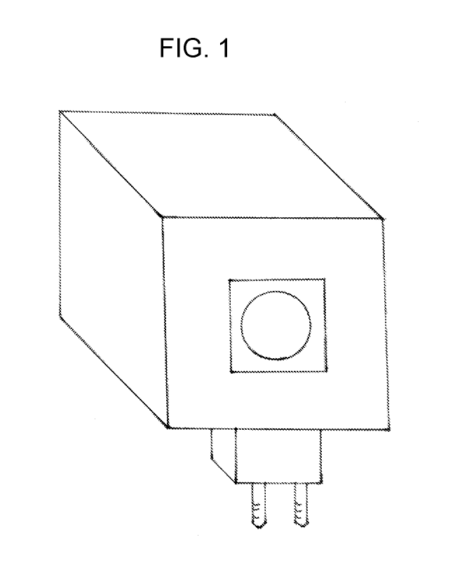

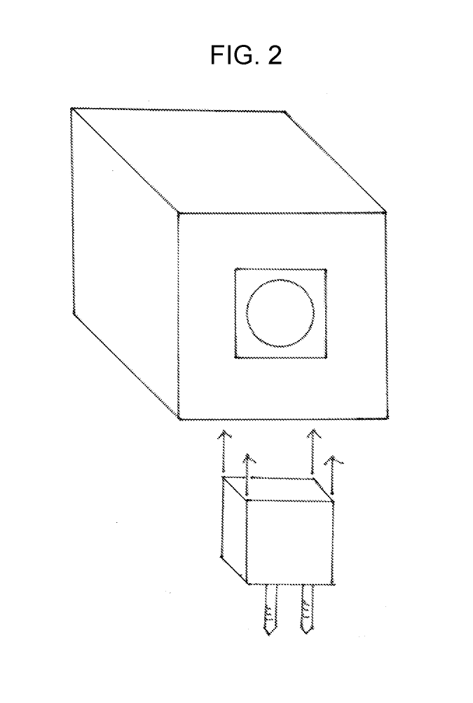

The light-producing sub-assembly and the electrical-power-contact sub-assembly can each take various forms. A complete high-output LED bulb-replacement assembly is depicted in FIG. 1, with the light-producing assembly shown as (10), the LED emitter shown as (12) and the electrical-power-contact sub-assembly shown as (14). FIG. 2 shows an exploded view of the constituent sub-assemblies, wherein the light-producing assembly is shown as (16), the electrical-power-contact sub-assembly is shown as (18) and the AC contact pins are shown as (20).

1. A means of facilitating the installation of a high-output LED bulb-replacement assembly into various Fresnel lighting instruments by separating the light-producing portion of the instrument from the electrical-power-contact portion of the instrument.

2. The method described in claim 1, as applied to any high-output LED bulb-replacement assembly designed for Fresnel lighting instruments.

3. The method described in claim 1, wherein the constituent sub-assemblies previously described take various forms and configurations to suit a particular Fresnel instrument.
